(19) United States
(12) Patent Application Publication
(10) Pub. No.: US 2016/0140693 A1
(43) Pub. Date: May 19, 2016

(54) SYSTEMS AND METHODS FOR OBSTRUCTING INOPERABLE PIXELS IN A DISPLAY DEVICE

(71) Applicant: Pixtronix, Inc., San Diego, CA (US)

(72) Inventor: Andrew William Sparks, Cambridge, MA (US)

(21) Appl. No.: 14/546,631

(22) Filed: Nov. 18, 2014

(51) Int. Cl. G06T 5/00; G09G 5/02; G09G 5/10

(52) U.S. Cl. CPC G06T 5/00; G09G 5/10; G09G 5/02; G09G 2300/0421

(57) ABSTRACT

This disclosure provides systems, methods and apparatus for optically obstructing inoperable display elements in a display apparatus. In one aspect, a display apparatus can include a plurality of display elements each having a shutter suspended over a substrate. The shutters can be capable of moving into and out of an optical path aligned with at least one aperture formed in a substrate. When a display element is inoperable, the shutter associated with the display element may be unable to block light passing through the aperture. To improve the quality of images formed on the display apparatus, the aperture associated with the inoperable display element can be optically obstructed, so that light directed toward the aperture is blocked even if the shutter is stuck in the open position. In some implementations, the aperture may be optically obstructed by a light-blocking pigment deposited over the aperture.

### TECHNICAL FIELD

This disclosure relates to the field of imaging displays, and to light modulators incorporated into imaging displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus can include display elements that modulate light by selectively moving a light-blocking component into and out of an optical path through an aperture defined through a light-blocking layer. Some of the display elements may become inoperable such that the light-blocking components cannot be moved into a position to fully block light. Inoperable display elements can result in lower quality images.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device including a display element substrate coupled to an aperture plate. The display device includes a plurality of display elements within a gap between the display element substrate and the aperture plate. The display device includes a first light-blocking layer within the gap on the display element substrate, the first light-blocking layer including at least one aperture associated with each display element. A second light-blocking layer is within the gap on the aperture plate. The second light-blocking layer includes an aperture associated with each aperture in the first light-blocking layer. A pigment is on at least one of the first light-blocking layer and the second light-blocking layer, optically obstructing at least one of the apertures.

In some implementations, the display device includes a backlight behind one of the display element substrate and the aperture plate. The pigment can be on the light-blocking layer nearest the backlight. In some implementations, the display device includes at least one partially dismantled display element at about the location of the aperture obstructed by the pigment. In some implementations, the pigment can be insoluble and substantially non-reactive with fluids. In some implementations, the pigment can be a black ink or an opaque resin.

In some implementations, the display device includes a processor capable of communicating with the display device. The processor can be capable of processing image data. The display device also can include a memory device capable of communicating with the processor. In some implementations, the display device can include a driver circuit capable of sending at least one signal to the display device and a controller capable of sending at least a portion of the image data to the driver circuit. In some implementations, the display device can include an image source module capable of sending the image data to the processor. The image source module can include at least one of a receiver, transceiver, and transmitter. In some implementations, the display device includes an input device capable of receiving input data and communicating the input data to the processor.

Another innovative aspect of the subject matter described in this disclosure can be implemented in a method of blocking inoperable pixels in a display device. The method includes identifying a location of at least one inoperable display element on a display element substrate. The inoperable display element includes a shutter unable to move into a fully closed position. The method includes depositing a pigment over at least one aperture in a light-blocking layer on at least one of the display element substrate and an aperture plate. The at least one aperture is associated with the identified location to optically obstruct the at least one aperture. The method includes bonding the display element substrate to the aperture plate.

In some implementations, identifying a location of at least one inoperable display element can include illuminating a first side of the display element substrate with a backlight. Identifying a location of at least one inoperable display element can include transmitting, to each of a plurality of display elements positioned over the display element substrate, a signal to cause a shutter associated with each of the plurality of display elements to move into a closed position. Identifying a location of at least one inoperable display element can include optically detecting a presence of light on a second side of the display element substrate at the location of the at least one inoperable display element. In some implementations, the method also can include removing at least a portion of the shutter of the at least one inoperable display element. In some implementations, depositing a pigment over at least one aperture in a light-blocking layer on at least one of the display element substrate and an aperture plate can include injecting a black ink into the at least one aperture.

Another innovative aspect of the subject matter described in this disclosure can be implemented in a display apparatus. The display apparatus includes a display element substrate coupled to an aperture plate. The display apparatus includes a plurality of light modulating means within a gap between the display element substrate and the aperture plate. The display apparatus includes a first optical aperture obstruction means associated with at least one inoperable light modulating means of the plurality of light modulating means. The optical aperture obstruction means prevents light from passing through the at least one inoperable light modulating means.

In some implementations, the display apparatus can include a light transmitting means behind one of the display element substrate and the aperture plate. In some implementations, the light transmitting means can be behind the display element substrate and the first optical aperture obstruction means can be over an interior surface of the display element substrate. In some implementations, the light transmitting means can be behind the aperture plate and the first optical aperture obstruction means can be over an interior surface of the aperture plate.

In some implementations, the first optical aperture obstruction means is insoluble and substantially non-reactive with fluids. In some implementations, the display apparatus can include a second optical aperture obstruction means. The first optical aperture obstruction means can be over the display element substrate and the second optical aperture obstruction means can be over the aperture plate. In some implementations, the at least one inoperable light modulating means can be partially dismantled.

Another innovative aspect of the subject matter described in this disclosure can be implemented in a system for blocking inoperable pixels in a display device. The system includes a controller capable of transmitting to each of a plurality of display elements over a display element substrate a signal causing a shutter associated with each of the plurality of display elements to move into a closed position. The system includes at least one test apparatus. The test apparatus is capable of identifying a location of at least one inoperable display element that does not move into the closed position in response to the transmitted signal and store the location of the at least one inoperable display element in a memory element. The system includes at least one repair apparatus. The repair apparatus is capable of receiving the location of the at least one inoperable display element from the memory element and depositing a pigment over at least one aperture associated with the location of the at least one inoperable display element to optically obstruct the at least one aperture.

In some implementations, the test apparatus includes a backlight behind the display element substrate and an optical detection system capable of identifying the location of the at least one inoperable display element. In some implementations, the repair apparatus includes an inkjet printer capable of depositing ink over the at least one aperture associated with the location of the at least one inoperable display element. In some implementations, the test apparatus and the repair apparatus are included within a single device.

In some implementations, the system also can include a shutter removal system capable of removing at least a portion of a shutter associated with the at least one inoperable display element prior to depositing the pigment. In some implementations, the shutter removal system can include at least one of a mechanical probe, an electrostatic probe, and a laser. In some implementations, the pigment can be deposited over at least one aperture on the display element substrate associated with the identified location to optically obstruct the at least one aperture. In some implementations, the pigment is deposited over at least one aperture on an aperture plate associated with the identified location to optically obstruct the at least one aperture.

Another innovative aspect of the subject matter described in this disclosure can be implemented in a system for blocking inoperable pixels in a display device. The system can include means for transmitting to each of a plurality of display elements over a display element substrate a signal causing a shutter associated with each of the plurality of display elements to move into a closed position. The system can include means for identifying a location of at least one inoperable display element that does not move into the closed position in response to the transmitted signal. The system can include means for optically obstructing at least one aperture associated with the location of the at least one inoperable display element.

In some implementations, the system can include means for illuminating a first side of the display element substrate and means for detecting a presence of light on a second side of the display element substrate at the location of the at least one inoperable display element. In some implementations, the system also can include means for removing at least a portion of a shutter associated with the at least one inoperable display element.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a cross-sectional view of an example display apparatus.

FIG. 4A shows an example system for optically obstructing an aperture associated with an inoperable display element.

FIG. 4B shows another example system for optically obstructing an aperture associated with an inoperable display element.

FIG. 5 shows a flow diagram of an example process for optically obstructing an aperture associated with an inoperable display element.

FIGS. 6A-6C show various views of an example display apparatus during the stages of an example implementation of the process shown in FIG. 5.

FIGS. 7A-7C show various views of the example display apparatus during the stages of an example implementation of the process shown in FIG. 5.

FIG. 8 show a cross-sectional view of the example display apparatus during a stage of an example implementation of the process shown in FIG. 5.

FIGS. 9A and 9B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display apparatus may include many thousands or millions of MEMS-based display elements. In some cases, during manufacturing, a fraction of the display elements experience fabrication defects. For example, some of the display elements may be stuck in an open, closed, or partially open state. Such display elements can be referred to as inoperable, disabled, immobile or stuck display elements. A display element also may be considered inoperable if it is not fully stuck, but has a limited range of motion such that it cannot enter a fully closed state. Display elements stuck in an open or partially open state, or otherwise unable to enter a fully closed state, may reduce the quality of images produced by the display device more than display elements stuck in a closed state. Image degradation due to inoperable display elements of such a display can be mitigated by rendering open or partially open inoperable display elements optically dark. Inoperable display elements can be rendered optically dark by obstructing the inoperable display elements within the display, rather than on an exterior surface of the display. This can be done by depositing a light-blocking pigment on an interior surface of a display element substrate or an aperture plate used to form the display, before the display element substrate is bonded to the aperture plate.

Shutter-based display elements are fabricated over a display element substrate. Drive voltages can be applied to the shutters of the display elements to cause the display elements to move into a closed position. A display element whose shutter does not move into the closed position can be identified as inoperable, and an aperture associated with the inoperable display element can be optically obstructed, for example by depositing a light-blocking pigment over the aperture. In some implementations, the obstructed aperture can be an aperture formed on the aperture plate. In some other implementations, the obstructed aperture can be an aperture formed on the display element substrate. To more easily access an aperture formed on the display element substrate, in some implementations, the shutter associated with the inoperable display element can be partially removed from the display element substrate.

Particular implementations of the subject matter described in this disclosure can be implemented to realize one or more of the following potential advantages. By optically obstructing an aperture associated with an inoperable display element, the quality of images produced by a display device can be improved. Inoperable display elements stuck in an open or partially open position can have a greater detrimental effect on the image quality of images produced by the display than inoperable display elements stuck in a fully closed position. For example, in some situations, a viewer may be more sensitive to a bright defect on a dark background, such as an inoperable display element stuck in an open position, than to a dark defect on a bright background, such as an inoperable display element stuck in a closed position. Therefore, converting a bright defect in a display apparatus into a dark defect can improve the quality of images produced by the display apparatus. Optically obstructing an open or partially open inoperable display element can therefore reduce the image degradation that results from the inoperable display element. By placing an optical obstruction, such as a light-blocking pigment, on an interior surface of the display element substrate or the aperture plate rather than an exterior surface, more of the light passing through the aperture at high angles can be blocked than if such a pigment were applied on an exterior surface. In some implementations, dark defects can be ignored, because they may not significantly reduce image quality.

In some implementations, the shutter of an inoperable display element can be removed before the corresponding aperture is obstructed. Removal of the shutter can permit access to an aperture over which the shutter was formed, so that the aperture can more easily be obstructed by deposition of a light-blocking pigment. In implementations in which a backlight is positioned behind the display element substrate, depositing a light-blocking pigment or other optical obstruction over an aperture formed in the display element substrate can be more effective than depositing the optical obstruction over an aperture formed in the aperture plate. This can enable blocking of the light before it enters the display element. The light can be reflected back into a waveguide associated with the backlight before the light is diffracted by the aperture formed in the display element substrate, and the possibility of light escaping into adjacent display elements can therefore be reduced. Similarly, in implementations in which the backlight is positioned behind the aperture plate, depositing a light-blocking pigment or other optical obstruction over an aperture formed in the aperture plate can be more effective than depositing the optical obstruction over an aperture formed in the display element substrate.

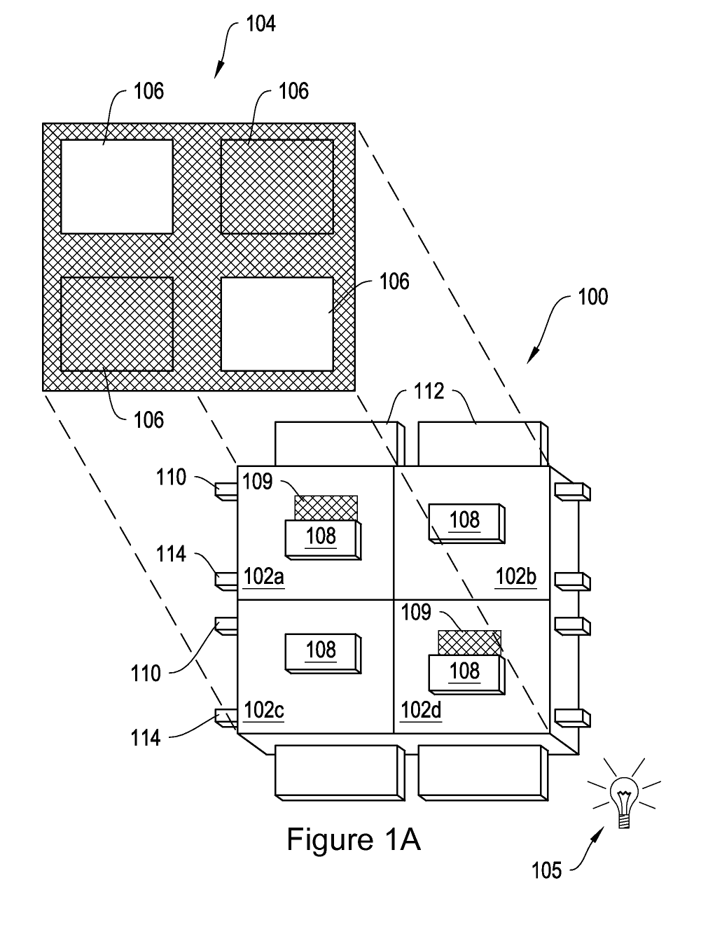

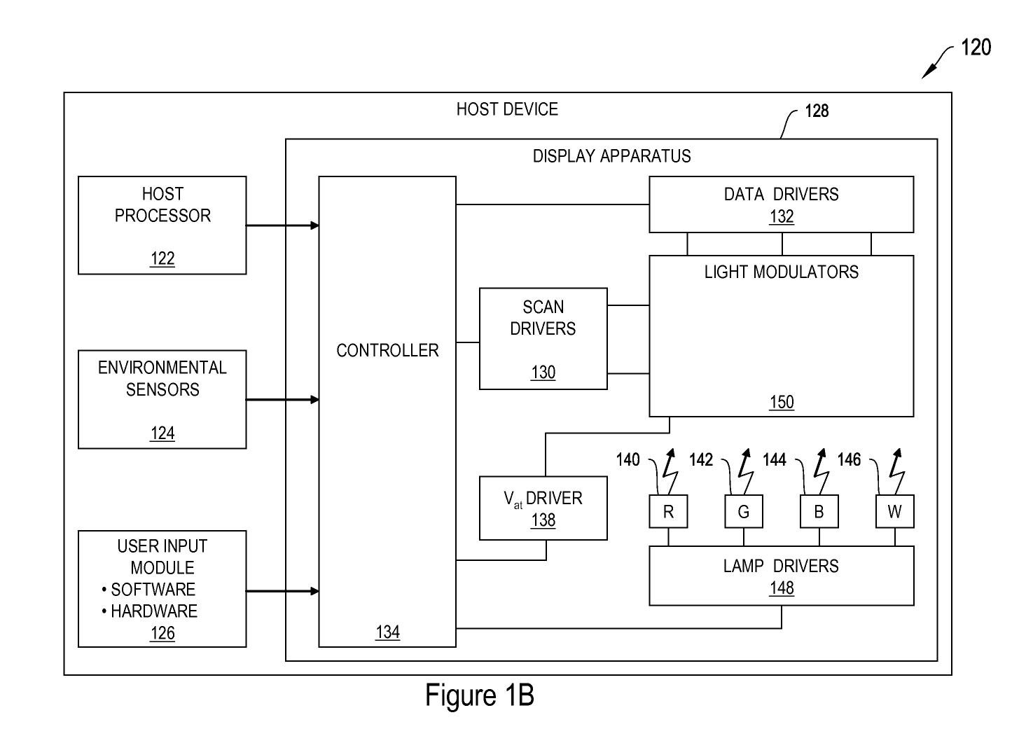

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

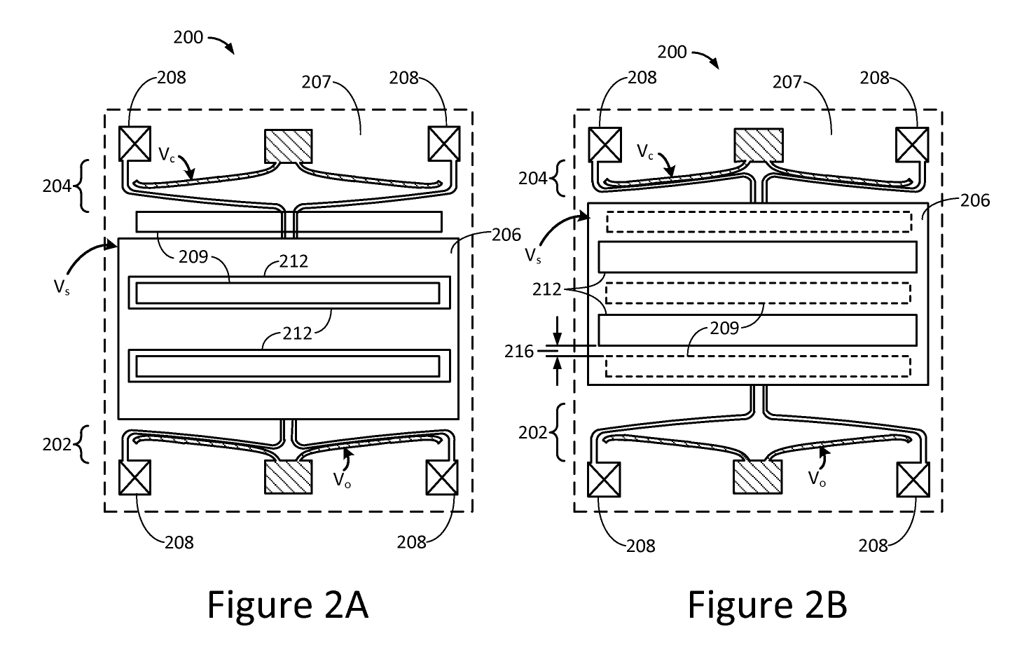

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light-blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light-blocking portions of the shutter 206 can be designed to overlap the edges of the apertures 209. FIG. 2B shows an overlap 216, which in some implementations can be predefined, between the edge of light-blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

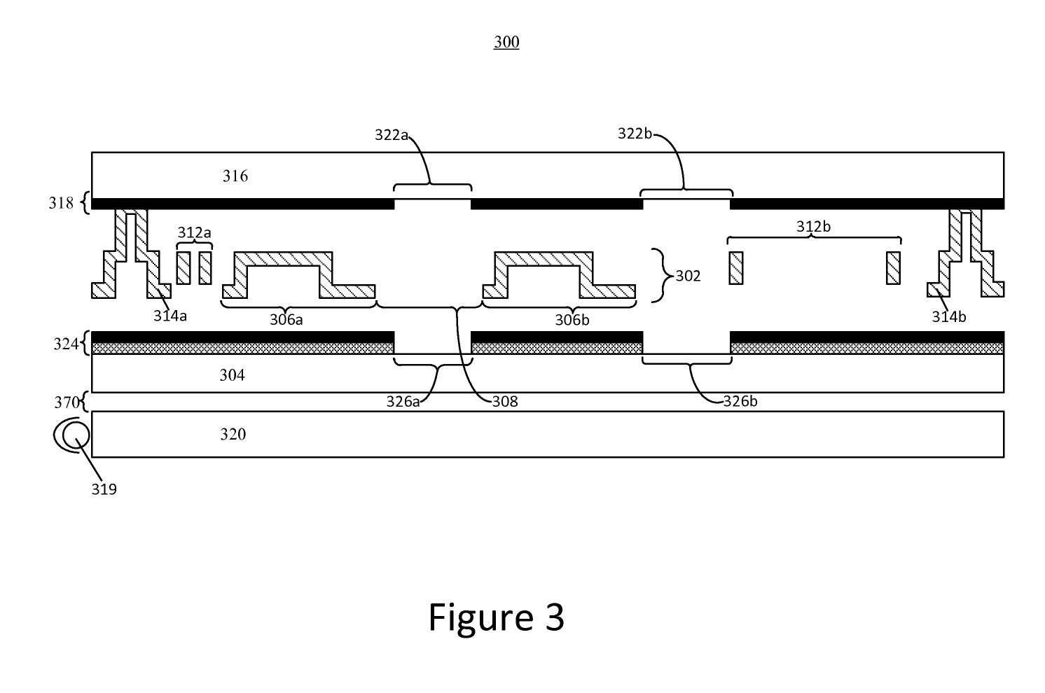

FIG. 3 shows a cross-sectional view of an example display apparatus 300. A shutter 302 is suspended between a front substrate 316 and a rear substrate 304. The shutter 302 includes left and right light-blocking portions 306a and 306b (generally referred to as light-blocking portions 306) and a shutter aperture 308. A shutter close actuator 312a and a shutter open actuator 312b (generally referred to as actuators 312) are positioned adjacent to the left light-blocking portion 306a and the right light-blocking portion 306b, respectively. The actuators 312 are capable of moving the shutter 302 laterally into open and closed positions, in response to actuation voltages. Anchors 314a and 314b (generally referred to as anchors 314) couple to the front substrate 316 and support the actuators 312 and the light-blocking portions 306 above the rear substrate 304.

A light-blocking layer 318 couples to the front substrate 316 and defines two front apertures 322a and 322b (generally referred to as front apertures 322). A light-blocking layer 324 is positioned on the front-facing surface of the rear substrate 304. The light-blocking layer 324 defines two rear apertures 326a and 326b (generally referred to as rear apertures 326). When the shutter is in an open position, as shown in FIG. 3, the front aperture 322a and the rear aperture 326a are aligned with the shutter aperture 308, while the right light-blocking portion 306b is positioned beside an optical path between the front aperture 322b and rear aperture 326b. A light source 319 and a light guide 320 (together forming a backlight) are positioned behind the rear substrate 304. The light guide 320 is separated from the rear substrate 304 by a gap 370. In some implementations, the gap 370 can be filled with air. In some other implementations, the gap 370 can be filled with another fluid (such as a gas or a liquid) or a vacuum. The fluid or vacuum filling the gap 370 can aid in extracting a desired angular distribution of light from the light guide 320.

In the open position shown in FIG. 3, the shutter 302 can allow the light passing through the rear apertures 326a and 326b to continue to pass towards the front substrate 316. In some implementations, the shutter 302 can be moved to the open position by applying a voltage across the pair of electrode beams that form the shutter open actuator 312a. Likewise, the shutter 302 can be moved into a closed position by applying a voltage across the pair of electrode beams that form the shutter close actuator 312b. However, in some cases the display element shown in FIG. 3 may become inoperable and as a result, the shutter 302 may become stuck in a closed position or an open position. For example, one or more of the components that form a driving circuit for a display element, such as a transistor, or one or more of the electromechanical components of the display element, such as an actuator, may be non-operational due to defects arising within the manufacturing process. For example, particles generated during the manufacturing process may settle within a display element, causing a short circuit or otherwise interfering with the motion of the shutter 302. Similarly, photolithography problems also may result in a short circuit that renders a display element inoperable. In some implementations, a liquid may fill the space between the front substrate 316 and the rear substrate 304. A display element may become inoperable due to air bubbles caused by incomplete liquid fill interfering with the motion of the shutter 302. Shutter motion also may be impacted by delamination of one or more metal layers used to form various components of the display, stiction between shutter 302 or actuator 312 components, or mechanical breakage of the actuators 312. In some implementations, a display device may include many thousands of display elements such as the display element shown in FIG. 3. Therefore, if a small number of display elements are inoperable, the display apparatus 300 may still be functional for producing images, because a small number of inoperable display elements may degrade the image quality slightly.

In some implementations, the quality of the images produced by a display device may be reduced more by a display element stuck in an open (or partially open) position than by a display element stuck in a closed position. This is because light escaping from an inoperable display element can be more noticeable by a viewer than an absence of light that results from a display element stuck in a closed position. For example, because the inoperable display elements are positioned relatively close to one another, the light emitted from display elements surrounding a display element stuck in the closed position can partially compensate for the lack of light emitted from the inoperable display element. Therefore, in some implementations, the reduction in image quality caused by inoperable display elements can be mitigated by rendering optically dark the display elements that are stuck in an open or partially open position.

In some implementations, an inoperable display element can be rendered optically dark even if the shutter 302 is stuck in an open position by obstructing one or both of the front apertures 322 and the rear apertures 326. When the front apertures 322 and/or rear apertures 326 are obstructed, light can be blocked regardless of the position of the shutter 322. In some implementations, the apertures 322 and 326 can be obstructed by depositing a light-blocking pigment, such as a black ink, over the apertures.

In some implementations, a pigment may be deposited on an exterior surface of the display apparatus 300. For example, the pigment may be applied on the front surface of the front substrate 316 or on the rear surface of the rear substrate 304. However, this may not fully prevent light from passing through the aperture. For example, because the front surface of the front substrate 316 is separated from the front apertures 322 by a distance equal to the thickness of the front substrate 316, light may still pass through the front apertures 322 at a high angle even if a light-blocking pigment is applied to the area of the front substrate 316 positioned over the front apertures 322. By the same principle, light can escape through the rear apertures 326 at a relatively high angle even if a light-blocking pigment is applied to the area of the rear substrate 304 positioned directly behind the rear apertures 326. Therefore, to fully prevent light from passing through the front apertures 322, it can be useful to apply an optical obstruction (such as a light-blocking pigment, resin, or other material) on an interior surface of the front substrate 316. Similarly, to fully prevent light from passing through the rear apertures 326, it can be useful to apply an optical obstruction on an interior surface of the rear substrate 304.

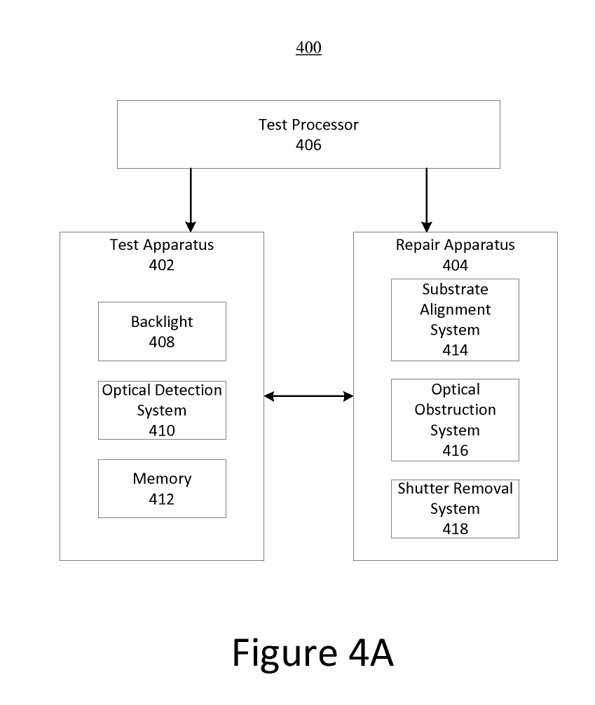

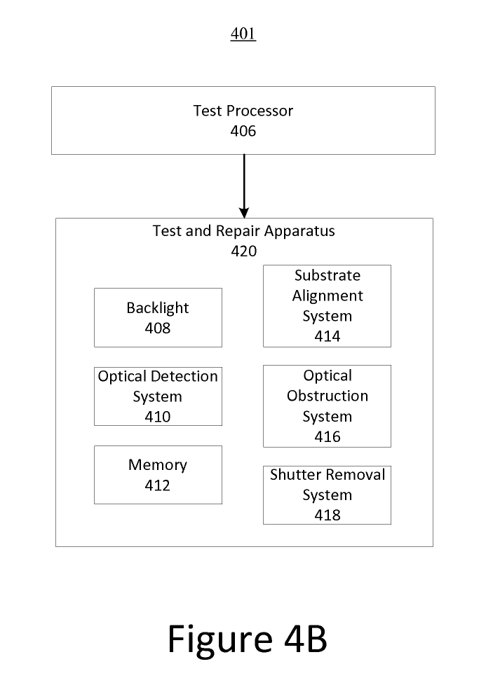

FIG. 4A shows a first example system 400 for optically obstructing an aperture associated with an inoperable display element. The system 400 includes a test apparatus 402, a repair apparatus 404, and a test processor 406 each in communication with one another. The test apparatus includes a backlight 408, an optical detection system 410, and memory 412. The repair apparatus 404 includes a substrate alignment system 414, an optical obstruction system 416, and a shutter removal system 418.

The test apparatus 402 can be used for determine whether there are any inoperable display elements in a partially formed display device and can identify the precise location of each inoperable display element before the display device is fully assembled. In some implementations, the test apparatus 402 can receive a partially formed display device. The partially formed display device may include a substrate on which a plurality of display elements have been fabricated. For example, the partially formed display device can include the front substrate 316 and all of the display elements formed on it. In other implementations, the partially formed display device may include a rear substrate on which display elements have been formed. Other components, such as the drivers 130, 132, and 138, and the controller 134 shown in FIG. 1B, also may be included in the partially formed display device.

In some implementations, the test processor 406 can control the test apparatus to determine the locations of inoperable display elements. The test processor 406 can control all of the display elements to move into their fully closed positions. In some implementations, the test processor 406 can control the display elements by communicating with the controller 134 shown in FIG. 1A. For example, in some implementations, the controller 134 may already be coupled to the display device. The test processor 406 can pass instructions to the controller 134 to cause the controller 134 to cause the drivers 130, 132, and 138 to command each of the display elements to move into a fully closed position. The test processor 406 can be implemented in a variety of ways. For example, in some implementations, the test processor 406 can be defined by computer instructions executing on a general purpose processor. In some other implementations, the test processor 406 can be implemented by special purpose logic circuitry, such as an FPGA (field programmable gate array) or an ASIC (application-specific integrated circuit). For example, the test processor 406 can include a collection of circuitry and logic instructions within an FPGA or ASIC. The test processor 406 also can include, in addition to hardware, code that creates an execution environment for the computer program in question, such as code that constitutes processor firmware, a protocol stack, an operating system, or a cross-platform runtime environment.

After the display elements have been controlled to move into their fully closed positions, the test processor 406 can control the backlight 408 of the test apparatus to turn on. In some implementations, the backlight can be positioned behind the substrate of the partially formed display device, such that the partially formed display device is illuminated from behind the substrate when the backlight 408 is turned on.

Because the display elements have been controlled to move into their fully closed positions, light emitted from the backlight 408 should not be able to pass through the display elements. Therefore, display elements that are inoperable and stuck in an open or partially open position (i.e., display elements that are not capable of properly responding to the commands from the test processor 406) will allow light to pass. In some implementations, the optical detection system 410 can be used to identify these inoperable display elements. For example, the optical detection system 410 can be positioned on the side of the partially formed display device opposite the side on which the backlight is positioned. In some implementations, the optical detection system 410 can be configured to detect light passing through inoperable display elements whose shutters are open or partially open. In some implementations, the optical detection system 410 can be a photodiode array capable of responding to light passing through the inoperable display elements. In some other implementations, the optical detection system 410 can be a camera having a sufficiently high resolution (i.e., a resolution equal to or greater than the resolution of the display apparatus) to detect individual inoperable display elements. In some implementations, the optical detection system 410 can be implemented as any type of optical sensor capable of identifying the locations of display elements whose shutters cannot fully close. The optical detection system 410 can identify a location associated with each inoperable display element, based on the locations on the partially formed display device where light is emitted. The test processor 406 can then control the optical detection system 410 to transmit the locations of the inoperable display elements to the memory 412 for storage.

After the locations of the inoperable display elements have been stored in the memory 412, the test processor 406 can control the repair apparatus 404 to render optically dark at least one aperture associated with each inoperable display element. In some implementations, the apertures to be rendered dark may be included on a second substrate that is not part of the partially formed display device tested by the test apparatus 402. For example, the test apparatus 402 can receive and test the display elements formed on the front substrate 316 shown in FIG. 3, and the repair apparatus 404 can render optically dark the corresponding apertures 326a and 326b on the rear substrate 304. In some other implementations, the apertures to be rendered optically dark can be included on the same substrate tested by the test apparatus 402.

The substrate alignment system 414 can be used to arrange the substrate including the apertures to be rendered optically dark according to a frame of reference. In some implementations, the substrate may include fiducials, such as visual markers placed in a known location on the substrate, which can be detected by the substrate alignment system 414. The substrate alignment system 414 can receive the substrate in a rough position, and can then move the substrate into a more accurate position based on the position of the fiducials. In some other implementations, the substrate alignment system 414 may merely register the position of the substrate without altering its position. The registered position can then be used by the optical obstruction system 416 and the shutter removal system 418.

After the substrate has been positioned or registered by the substrate alignment system 414, the repair apparatus 404 can receive the locations of the inoperable display elements from the memory 412, and the optical obstruction system 416 can optically obstruct at least one aperture associated with each inoperable display element. In some implementations, the optical obstruction system 416 can be capable of depositing a light-blocking pigment over the apertures associated with the inoperable display elements. For example, the optical obstruction system 416 can be an inkjet printer capable of depositing a black ink over the apertures. In some other implementations, the optical obstruction system 416 can include a laser or ion beam capable of roughening the surface of the substrate at a location corresponding to the location of the inoperable display elements. A roughened surface can reduce the amount of light that is permitted to pass through the aperture by diffusing light from the backlight and reflecting at least a portion of the light back towards the backlight. In some other implementations, the optical obstruction system 416 can include a system for depositing and patterning a light-blocking metal over the apertures corresponding to the inoperable display elements.

In some implementations, the shutter removal system 418 can be used to remove at least a portion of the shutter of each inoperable display device. For example, in implementations in which the apertures to be rendered optically dark are positioned on the same substrate on which the display elements are formed, it may be useful to remove the shutter of an inoperable display element in order to render the corresponding aperture optically dark. Removal of the shutter can allow more direct access to the corresponding aperture, so that there is more space for the optical obstruction system 416 to obstruct the aperture. In some implementations, the shutter removal system can include an electrostatic or mechanical probe for removing the shutter from the inoperable display element. In some implementations, the shutter removal system can include a laser capable of separating the shutter from the inoperable display element.

FIG. 4B shows a second example system 401 for optically obstructing an aperture associated with an inoperable display element. The system 401 is similar to the system 400 shown in FIG. 4A. The primary difference between the system 400 and the system 401 is that the system 401 incorporates the functionality of the test apparatus 402 and the repair apparatus 404 into the same housing, as shown in FIG. 4B. The test and repair apparatus 420 includes components similar to those shown in the test apparatus 402 and repair apparatus 404 shown in FIG. 4A. For example, the test and repair apparatus 420 includes a backlight 408, an optical detection system 410, a memory 412, a substrate alignment system 414, an optical obstruction system 416, and a shutter removal system 418.

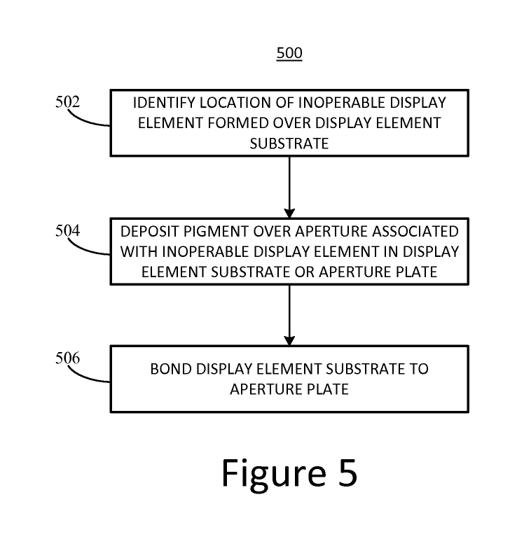

FIG. 5 shows a flow diagram of an example process 500 for optically obstructing an aperture associated with an inoperable display element. In brief overview, the process 500 includes identifying a location of at least one inoperable display element formed on a display element substrate (stage 502). A pigment is deposited over at least one aperture in a light-blocking layer formed on at least one of the display element substrate and an aperture plate (stage 504). The display element substrate is then bonded to the aperture plate (stage 506).

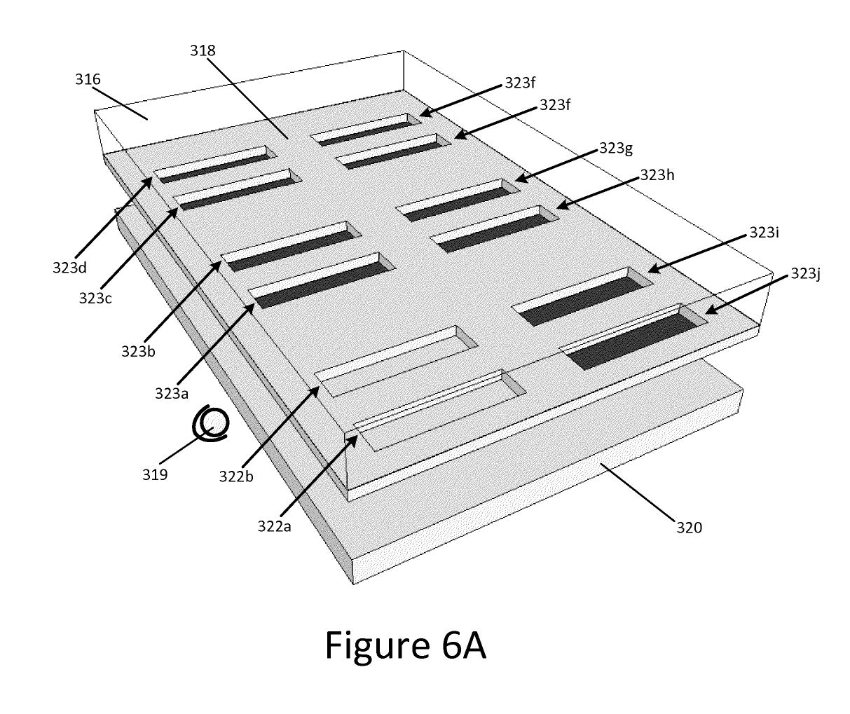

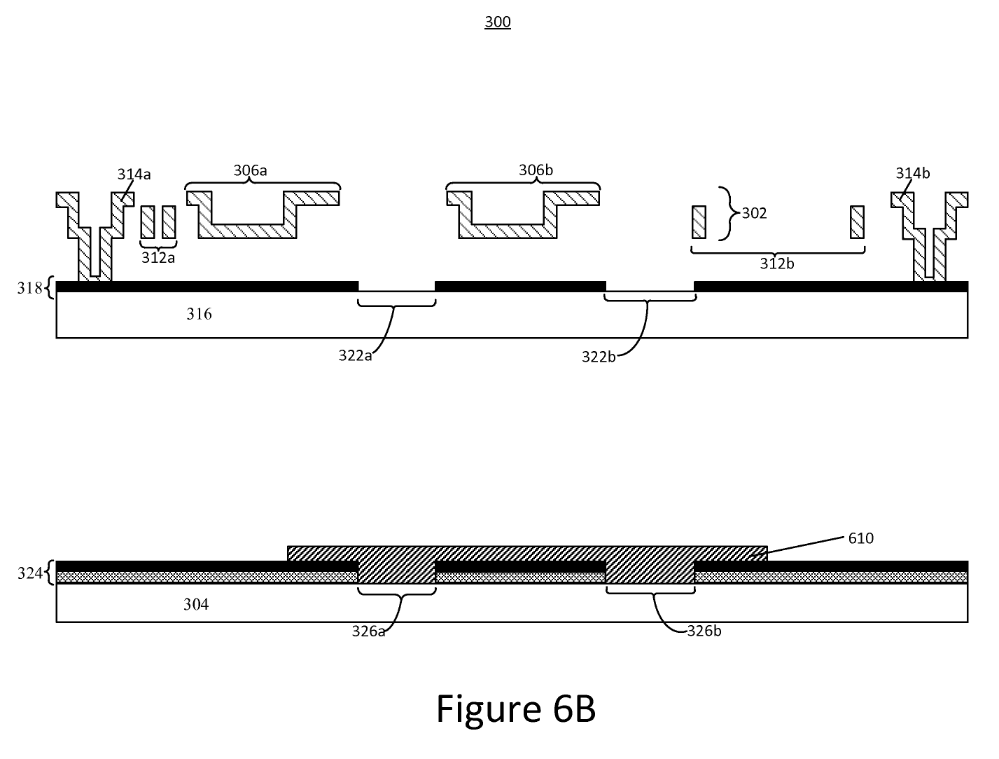

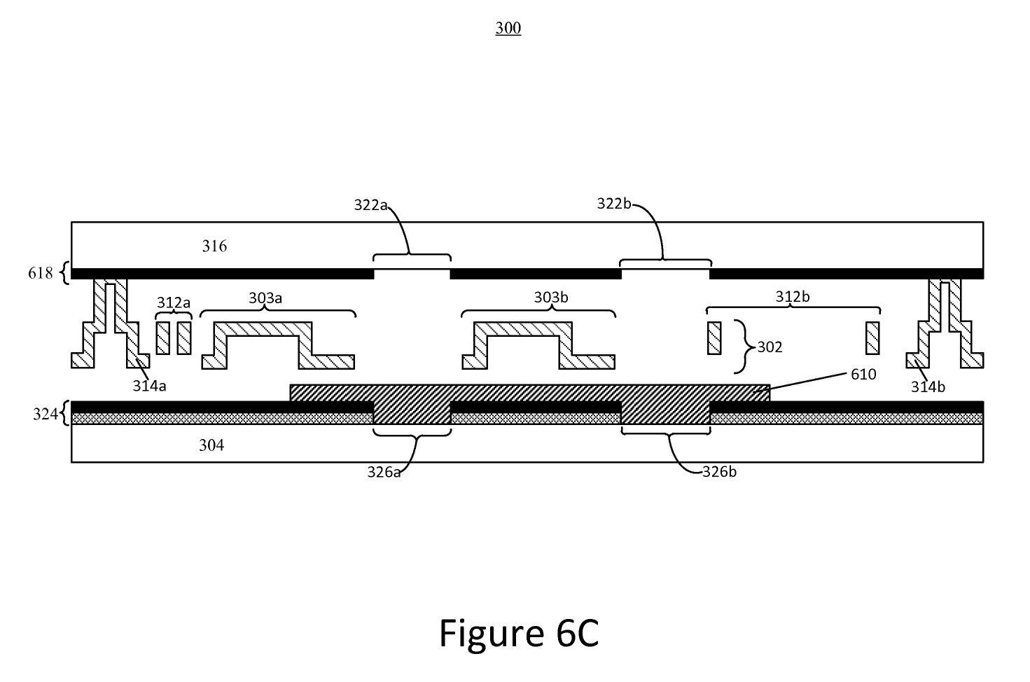

FIGS. 6A-6C show various views of an example display apparatus 300 during the stages of an example implementation of the process 500 shown in FIG. 5. The display apparatus 300 is the same as the display apparatus 300 shown in FIG. 3, and like reference numerals refer to like components. For simplicity, not all of the components of the display apparatus 300 are shown. The process 500 includes identifying a location of at least one inoperable display element formed on a display element substrate (stage 502). An inoperable display element can be identified by controlling the shutters of a plurality of display elements to move into a fully closed position and determining which display elements fail to move into the closed position, as discussed above in connection with FIG. 4A. For example, the display element substrate can correspond to the front substrate 316 on which the shutter 302 is formed. When the shutter 302 is controlled to move into a closed position, the light-blocking portions 306a and 306b of the shutter 302 should move to obstruct the front apertures 322a and 322b, respectively. If the shutter 302 does not move to obstruct the front apertures 322a and 322b, as shown in FIG. 6A, then the corresponding display element can be identified as inoperable.

FIG. 6A shows a perspective view of a portion of the transparent display element substrate 316 during stage 502 of the process 500. The light-blocking layer 318 is positioned on a rear surface of the display element substrate 316. The light-blocking layer 318 includes front apertures 322a and 322b of the inoperable display element, as well as several other front apertures 323a-323j associated with other display elements. A light source 319 and a light guide 320, together forming a backlight, are positioned behind the display element substrate 316, and the shutters of all of the display elements have been controlled to move into a closed position. If all of the shutters of the display elements were functioning properly, no light emitted from the backlight would pass through the display element substrate 316. As shown in FIG. 6A, the front apertures 322a and 322b are unobstructed and allow light to pass, indicating that the display element associated with the front apertures 322a and 322b is inoperable. In some implementations, after the shutters of the display elements are controlled to move into a closed position, an optical detector can determine whether light is able to pass through their corresponding front apertures 322 and 323. A display element can be identified as inoperable if light passing through a corresponding front aperture 322 or 323 is detected by the optical detector.

The process 500 includes depositing a pigment over at least one aperture in a light-blocking layer formed on at least one of the display element substrate and an aperture plate (stage 504). As discussed above, the shutter 302, anchors 314a and 314b, and actuators 312a and 312b are formed over the front substrate 316, and therefore the front substrate 316 serves as the display element substrate while the rear substrate 304 serves as an aperture plate. FIG. 6B shows cross-sectional views of the aperture plate 304 and the display element substrate 316 after a pigment 610 has been deposited on the aperture plate 304. In FIG. 6B, the aperture plate 304 has not yet been bonded to the display element substrate 316. The pigment 610 is deposited to fully obstruct the rear apertures 326a and 326b formed in the light-blocking layer 324. In some implementations, depositing the pigment 610 over the rear apertures 326a and 326b can be accomplished more readily than depositing the pigment 610 over the front apertures 322a and 322b, because access to the front apertures 322a and 322b is partially blocked by the presence of the shutter 302. In some implementations, a fluid can fill the space between the display element substrate 316 and the aperture plate 304 after they are subsequently bonded to one another. The pigment 610 can be selected to be insoluble and non-reactive with the fluid, so that the pigment 610 will not be dissolved by, or react with, the fluid over time.

The display element substrate 316 is then bonded to the aperture plate 304 (stage 506). The results of this stage are shown in FIG. 6C. As shown in FIG. 6C, the aperture plate 304 and the display element substrate 316 are positioned to face one another with the rear apertures 326a and 326b aligned with the front apertures 322a and 322b, respectively. The aperture plate 304 and the display element substrate 316 can be bonded to one another, for example, by an epoxy or other adhesive positioned around their perimeter edges. Although the shutter 302 remains in the open position, light cannot exit the display through the front apertures 322a and 322b because the corresponding rear apertures 326a and 326b are obstructed by the pigment 610, thus rendering the inoperable display element optically dark. This can mitigate the reduction in image quality caused by the inoperable display element.

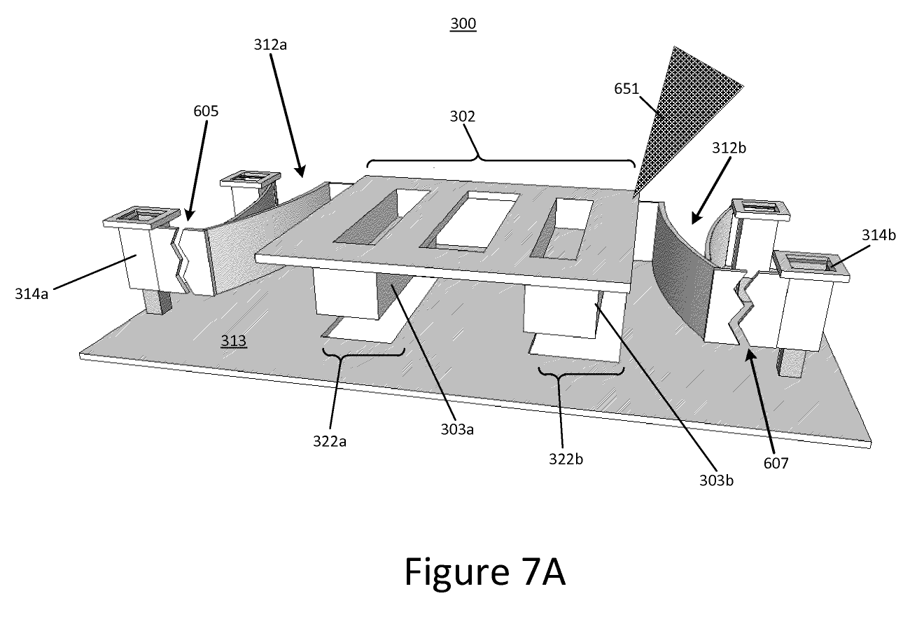

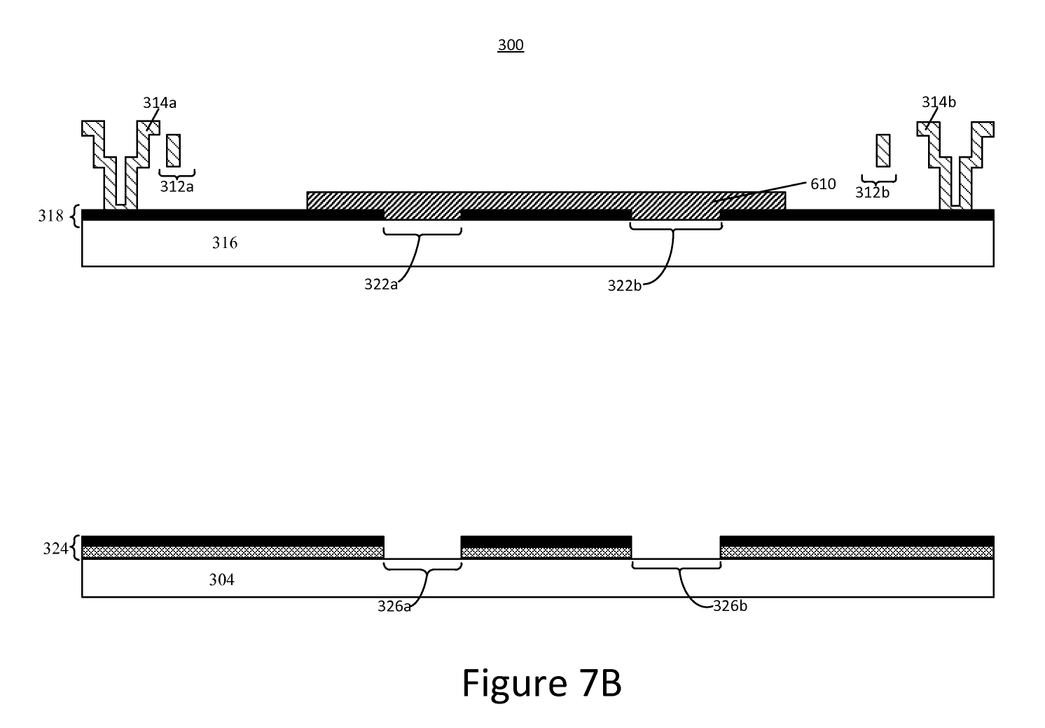

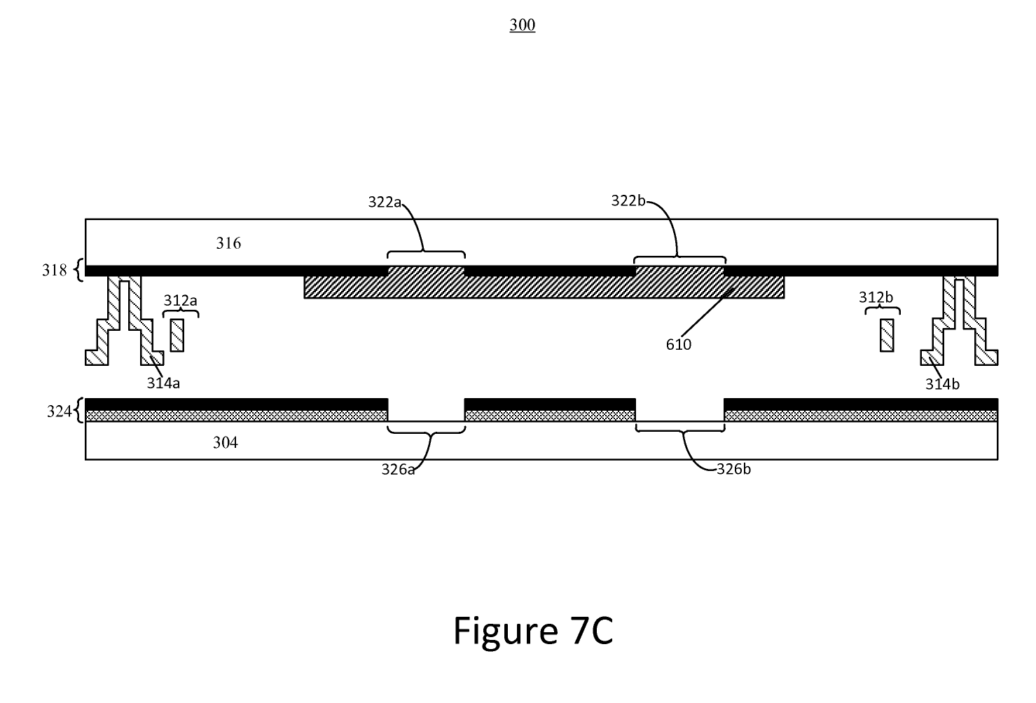

FIGS. 7A-7C show various views of the example display apparatus 300 during the stages of an example implementation of the process 500 shown in FIG. 5. The display apparatus 300 is to the same as the display apparatus 300 shown in FIG. 3, and like reference numerals refer to like components. For simplicity, not all of the components of the display apparatus 300 are shown. In contrast to the example implementation of the process 500 shown in FIGS. 6A-6C, in which a pigment was applied to apertures in the aperture plate 304, in the second example implementation of the process 500 shown in FIGS. 7A-7C, a pigment 610 is applied to the apertures 322a and 322b formed in the display element substrate 316.

In implementations in which the pigment 610 is deposited over apertures 322a and 322b formed in the display element substrate 316 rather than apertures formed in the aperture plate 304, the process 500 also can include removing at least a portion of a shutter 302 associated with an inoperable display element. For example, the shutter 302 can be removed by a mechanical or electrostatic probe, by a laser, or by a combination thereof. As shown in the perspective view of FIG. 7A, a joint coupling the shutter 302 to the anchor 314a can be broken at the point labeled 605 and a joint coupling the shutter 302 to the anchor 314b can be broken at the point labeled 607, to allow the shutter 302 to be removed. Then, a probe 651 can be used to remove the shutter 302 from the display element. Removal of the shutter 302 can allow better access to the underlying display element substrate 316, so that the front apertures 322a and 322b can be obstructed more easily.

After the shutter 302 is removed, a pigment is deposited over the apertures 322a and 322b in the light-blocking layer 318 formed on the display element substrate 316 (stage 504). The results of this stage are shown in FIG. 7B. The aperture plate 304 has not yet been bonded to the display element substrate 316. The display element substrate 316 is shown with the anchors 314a and 314b, as well as portions of the actuators 312a and 312b which still remain over the display element substrate 316 after the shutter 302 has been removed. The pigment 610 is deposited over the display element substrate 316. The pigment 610 is deposited to fully obstruct the front apertures 322a and 322b formed in the light-blocking layer 318. Also shown in FIG. 7B is a cross-sectional view of the aperture plate 304.

The display element substrate 316 is then bonded to the aperture plate 304 (stage 506). The results of this stage are shown in FIG. 7C. As shown in FIG. 7C, the aperture plate 304 and the display element substrate 316 are positioned to face one another with the rear apertures 326a and 326b aligned with the front apertures 322a and 322b, respectively. In this implementation, the shutter 302 is completely removed from the display apparatus 300. However, light cannot exit the display apparatus 300 through the front apertures 322a and 322b because they are obstructed by the pigment 610, thus rendering the inoperable display element optically dark.

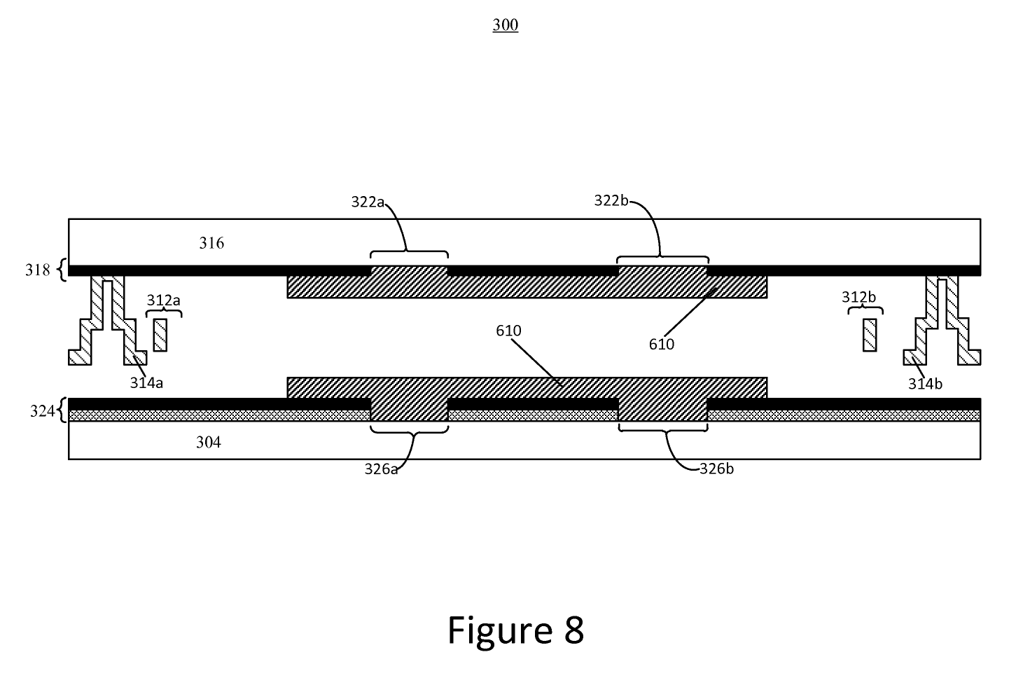

FIG. 8 show a cross-sectional view of the example display apparatus during a stage of an example implementation of the process shown in FIG. 5. In this implementation, the pigment 610 is deposited over both the aperture plate 304, as shown in FIG. 6B, and over the display element substrate 316, as shown in FIG. 7B. FIG. 8 shows the display apparatus 300 after the display element substrate 316 has been bonded to the aperture plate 304 (stage 504) when pigment 610 has been deposited over the apertures 322a and 322b in the light-blocking layer 318 formed on the display element substrate 316, and over the apertures 326a and 326b in the light-blocking layer 324 formed on the aperture plate 304. The shutter 302 is removed from the display apparatus 300, and the pigment 610 is deposited to obstruct the rear apertures 326a and 326b, as well as the front aperture 322a and 322b. This can help to more fully prevent light from passing through the inoperable display element.

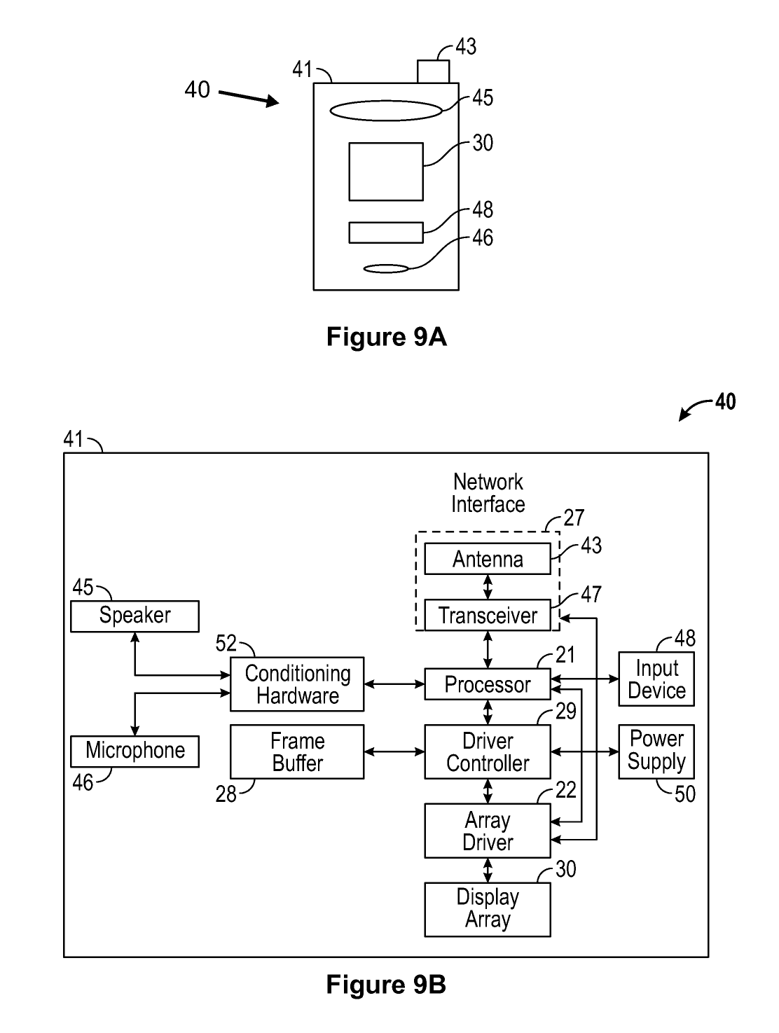

FIGS. 9A and 9B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 9B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a display element substrate coupled to an aperture plate;
a plurality of display elements within a gap between the display element substrate and the aperture plate;
a first light-blocking layer within the gap on the display element substrate, the first light-blocking layer including at least one aperture associated with each display element;
a second light-blocking layer within the gap on the aperture plate, the second light-blocking layer including an aperture associated with each aperture in the first light-blocking layer; and
a pigment on at least one of the first light-blocking layer and the second light-blocking layer, the pigment optically obstructing at least one of the apertures.

2. The display device of claim 1, further comprising a backlight behind one of the display element substrate and the aperture plate, wherein the pigment is on the light-blocking layer nearest the backlight.

3. The display device of claim 1, further comprising at least one partially dismantled display element at about the location of the aperture obstructed by the pigment.

4. The display device of claim 1, wherein the pigment is insoluble and substantially non-reactive with fluids.

5. The display device of claim 1, wherein the pigment is one of a black ink and an opaque resin.

6. The display device of claim 1, further comprising:
a processor capable of communicating with the display device, the processor being capable of processing image data; and
a memory device capable of communicating with the processor.

7. The display device of claim 6, further comprising:
a driver circuit capable of sending at least one signal to the display device; and
a controller capable of sending at least a portion of the image data to the driver circuit.

8. The display device of claim 6, further comprising:
an image source module capable of sending the image data to the processor, wherein the image source module includes at least one of a receiver, transceiver, and transmitter.

9. The display device of claim 6, further comprising:
an input device capable of receiving input data and communicating the input data to the processor.

10. A method of blocking inoperable pixels in a display device, comprising:
identifying a location of at least one inoperable display element on a display element substrate, the inoperable display element including a shutter unable to move into a fully closed position;
depositing a pigment over at least one aperture in a light-blocking layer on at least one of the display element substrate and an aperture plate, the at least one aperture associated with the identified location to optically obstruct the at least one aperture; and
bonding the display element substrate to the aperture plate.

11. The method of claim 10, wherein identifying a location of at least one inoperable display element further comprises:
illuminating a first side of the display element substrate with a backlight;
transmitting, to each of a plurality of display elements positioned over the display element substrate, a signal to cause a shutter associated with each of the plurality of display elements to move into a closed position; and
optically detecting a presence of light on a second side of the display element substrate at the location of the at least one inoperable display element.

12. The method of claim 10, further comprising removing at least a portion of the shutter of the at least one inoperable display element.

13. The method of claim 10, wherein depositing a pigment over at least one aperture in a light-blocking layer on at least one of the display element substrate and an aperture plate comprises injecting a black ink into the at least one aperture.

14. A display apparatus comprising:
a display element substrate coupled to an aperture plate;
a plurality of light modulating means within a gap between the display element substrate and the aperture plate; and
a first optical aperture obstruction means associated with at least one inoperable light modulating means of the plurality of light modulating means, the optical aperture obstruction means preventing light from passing through the at least one inoperable light modulating means.

15. The display apparatus of claim 14, further comprising a light transmitting means behind one of the display element substrate and the aperture plate.

16. The display apparatus of claim 15, wherein the light transmitting means is behind the display element substrate and the first optical aperture obstruction means is over an interior surface of the display element substrate.

17. The display apparatus of claim 15, wherein the light transmitting means is behind the aperture plate and the first optical aperture obstruction means is over an interior surface of the aperture plate.

18. The display apparatus of claim 14, wherein the first optical aperture obstruction means is insoluble and substantially non-reactive with fluids.

19. The display apparatus of claim 14, further comprising a second optical aperture obstruction means, wherein the first optical aperture obstruction means is over the display element substrate and the second optical aperture obstruction means is over the aperture plate.

20. The display apparatus of claim 14, wherein the at least one inoperable light modulating means is partially dismantled.
